(19) United States
(12) Patent Application Publication
(10) Pub. No.: US 2014/0035794 A1
(43) Pub. Date: Feb. 6, 2014

(54) DUAL DISPLAY COMPUTING DEVICE

(71) Applicant: Yifan Chen, Shanghai (CN)

(72) Inventor: Yifan Chen, Shanghai (CN)

(73) Assignee: GOOGLE INC., Mountain View, CA (US)

(21) Appl. No.: 13/295,453

(22) Filed: Nov. 14, 2011

Related U.S. Application Data
(63) Continuation of application No. PCT/CN2011/001121, filed on Jul. 6, 2011.

(51) Int. Cl. G09G 5/00

(52) U.S. Cl. 345/1.3

(57) ABSTRACT

In one general aspect, an apparatus can include a first electronic-ink display on a first electronic-ink display on a first side of the computing device, and a second electronic-ink display on a second side of the computing device. The second electronic-ink display is configured to selectively reflect ambient light to create a desired image. The apparatus can also include a sensor configured to produce an indicator that the first electronic-ink display of the computing device is rotated from facing in a first direction toward facing in a second direction opposite the first direction, and a refresh module configured to trigger the second electronic-ink display to refresh the image display by the second electronic-ink display in response to the indicator.

### CROSS-REFERENCE TO RELATED APPLICATION

This application is a continuation under 35 U.S.C. §§111(a) and 120 of PCT Patent Application No. PCT/CN2011/001121, filed Jul. 6, 2011, entitled “DUAL DISPLAY COMPUTING DEVICE,” which is incorporated by reference herein in its entirety.

### TECHNICAL FIELD

This description relates to a dual display computing device.

### BACKGROUND

Many types of electronic devices have been developed for consuming various types of media. For example, some electronic devices have been developed specifically for the purpose of reading electronic books (i.e., e-books). These types of dedicated book reading electronic devices can be referred to as e-book devices or as e-readers. Known e-book devices often incorporate electronic-ink (i.e., e-ink) display technology, which facilitate portability, readability in bright sunlight (because the electronic paper can reflect light like ordinary paper), relatively long battery life (because power may generally be consumed only during screen refreshing), and so forth. However, displays based on electronic-ink technology can have relatively slow refresh rates that may not be desirable for some applications and/or may not preferred by some e-book device users.

### SUMMARY

In one general aspect, an apparatus can include a first electronic-ink display on a first electronic-ink display on a first side of the computing device, and a second electronic-ink display on a second side of the computing device. The second electronic-ink display is configured to selectively reflect ambient light to create a desired image. The apparatus can also include a sensor configured to produce an indicator that the first electronic-ink display of the computing device is rotated from facing in a first direction toward facing in a second direction opposite the first direction, and a refresh module configured to trigger the second electronic-ink display to refresh the image display by the second electronic-ink display in response to the indicator.

In another general aspect, a computer-readable storage medium can store instructions that when executed cause a computing device to perform a process. The instructions can include instructions to trigger display of a first page of content within a first display on a first side of the computing device that is in a position facing toward a face of a user, and receive an indicator that the computing device is rotated such that the first display is moved from the position facing toward the face of the user and a second display on a second side of the computing device is moved from a position facing away from the face of the user. The instructions can also include instructions to replace the first page of content with a second page of content within the first display in response to the indicator.

In yet another general aspect, a computer-readable storage medium can store instructions that when executed cause a computing device to perform a process. The instructions can include instructions to trigger display of a first page of content within a first display of the computing device, and trigger display of a second page of content within a second display of the computing device. The instructions can also include instructions to receive an indicator that a user changes from viewing the first display to viewing the second display, and trigger display of a third page of content within the first display in response to the indicator.

The details of one or more implementations are set forth in the accompanying drawings and the description below. Other features will be apparent from the description and drawings, and from the claims.

### BRIEF DESCRIPTION OF THE DRAWINGS

FIGS. 1A through 1C are diagrams of a computing device with multiple displays.

FIGS. 2A through 2C are timing diagrams that illustrate operation of a computing device, according to an embodiment.

FIG. 3 is a diagram that illustrates a front side of a computing device that includes an image capture device.

FIGS. 4A and 4B are diagrams that illustrate rotation of a computing device with multiple displays.

FIG. 5 is a block diagram that illustrates a computing device that includes multiple displays.

FIG. 6 is a flowchart that illustrates a method of operating a computing device that has multiple displays.

FIGS. 7A through 7C are diagrams of a computing device that includes multiple displays and that can change configuration.

FIG. 8 is a flowchart that illustrates a method for refreshing content of a computing device with multiple displays.

FIG. 9 is a diagram of a computing device that includes an input device region.

### DETAILED DESCRIPTION

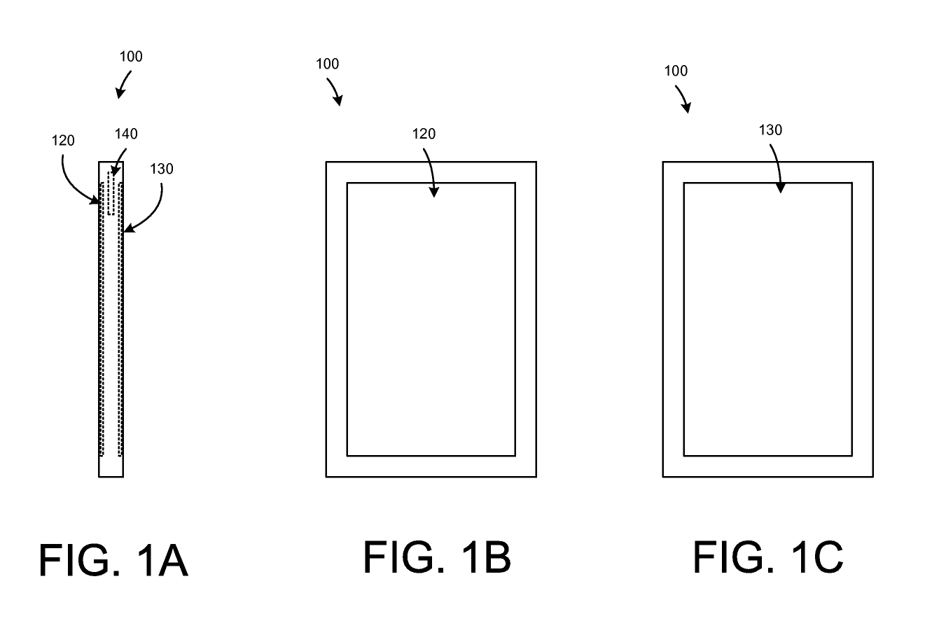

FIG. 1A is a diagram of a side view of a computing device 100 that has multiple displays. Specifically, the computing device 100 has a display 120 on one side of the computing device 100 and a display 130 on another side of the computing device 100. FIG. 1B is a diagram of the computing device 100 shown in FIG. 1A with the display 120 facing out of the page so that content displayed (e.g., rendered) on the display 120 may be viewed when facing the display 120. Accordingly, the display 130 is not shown in FIG. 1B because the display 130 is disposed behind the display 120 (and is facing in a direction opposite the display 120). FIG. 1C is a diagram of the computing device 100 shown in FIG. 1A with the display 130 facing out of the page so that content displayed (e.g., rendered) on the display 130 may be viewed when facing the display 130. Accordingly, the display 120 is not shown in FIG. 1C because the display 120 is disposed behind the display 130 (and is facing in a direction opposite the display 120).

The computing device 100 shown in FIG. 1A can be configured as an electronic device configured specifically for (i.e., dedicated for) the purpose of reading electronic books (i.e., e-books). Accordingly, the computing device 100, in some embodiments, can be referred to as an e-book device or as an e-reader.

The computing device 100 is configured so that a user can consume (e.g., read, view) content (e.g., text, images) displayed (e.g., rendered) on a first display facing the user while a second display is facing away from the user. The user then can rotate (e.g., flip) the computing device 100 so that subsequent content can be consumed on the second display (which was previously facing away from the user). While the first display is now facing away from the user, the first display can be refreshed so that additional content can later be consumed by the user when the computing device 100 is once again rotated (e.g., flipped). Thus, a user can read pages from an e-book by rotating (e.g., flipping) the computing device 100 as the pages are refreshed, in order, on the displays in, for example, an alternating fashion.

In some embodiments, when a display (e.g., display 120) of the computing device 100 is facing toward a user so that the user can view the display, the display can be referred to as being in a front orientation, or as being in a front-side orientation (e.g., a viewable or user-facing orientation). In some embodiments, when a display (e.g., display 130) of the computing device 100 is facing away from a user so that the user may not view the display, the display can be referred to as being in a back orientation, or as being in a back-side orientation (e.g., a non-viewable orientation).

As a specific example, the computing device 100 can be configured so that a first page of an e-book can be displayed (e.g., rendered) on, for example, display 120, which can be facing a user (or facing in a usable direction) as shown in FIG. 1B. While the user is reading the first page on the display 120, the display 130 can be configured to display a second page of the e-book. After the user has read the first page of the e-book displayed on the display 120, the user can rotate the computing device 100 so that the display 130 is facing the user and the display 120 is facing away from the user as shown in FIG. 1C. After, or while, the computing device 100 is being rotated so that the user can read the second page of the e-book displayed on the display 130, the display 120 can be refreshed with the third page of the e-book.

In this embodiment, the display 120 and the display 130 are each electronic ink displays based on electronic ink (e.g., e-ink, electronic paper) technology, which selectively reflect ambient light to create a desired image on the display. Electronic ink displays can include a thin layer (e.g., hydrocarbon oil layer) in which small reflective particles (e.g., titanium dioxide particles) are suspended. The particles can be electrostatically charged, and the application of a potential difference between different sides of the layer can cause particles in selected parts of the display to migrate electrophoretically to one side of the thin layer or the other. Parts of the display in which the reflective particles are disposed in the layer close to a surface of the display can reflect ambient light toward a viewer of the display, while parts of the display in which the reflective particles are disposed in the layer away from the surface of the display can absorb ambient light. By controlling the portions of the display in which the reflective particles are disposed toward and away from the display surface a desired image can be created. In other words, a mixture of particles suspended within a layer (e.g., thin oil layer) can be placed between parallel, conductive plates, and when voltages are applied across the plates, the particles can migrate electrophoretically to the front plate or the back plate to form pixels (e.g., white pixels, black pixels). Thus, each of the displays 120, 130, unlike a conventional flat panel display (such as a display based on liquid crystal display (LCD) technology) that uses backlighting to illuminate its pixels, is configured to display (e.g., hold) text and/or images without drawing (or substantially without drawing) electricity. Instead, the displays 120, 130 consume power when being refreshed, but not when a static image is being displayed. In some embodiments, the displays 120, 130 can be produced using various types of plastic substrate and/or display processing technologies.

In some embodiments, the electronic ink technology used to produce the displays 120, 130 can include a variety of technologies. For example, the displays 120, 130 can be based on Gyricon electronic paper technology, which includes polyethylene spheres. As yet another example, the displays 120, 130 can be based on Electro-wetting display (EWD) technology, which is based on controlling the shape of a confined water/oil interface by an applied voltage. When no voltage is applied, the oil (e.g., colored oil) can form a film between the water and a hydrophobic (water-repellent), insulating coating of an electrode, resulting in a pixel (e.g., a colored pixel).

As shown in FIG. 1A, the computing device 100 can include a sensor 140. The sensor 140 can be used to determine an orientation of the computing device 100. Specifically, the sensor 140 can be used to determine whether the display 120 or the display 130 is facing in a particular direction (e.g., in a direction facing a user). In some embodiments, the sensor can be configured to produce an indicator (e.g., a signal) that the display 120 or the display 130 is facing in a specified direction. Accordingly, the indicator produced by the sensor 140 can be used to trigger display of (e.g., refreshing of) content on one or more of the displays 120, 130 when (e.g., before, after, while) the computing device 100 is rotated.

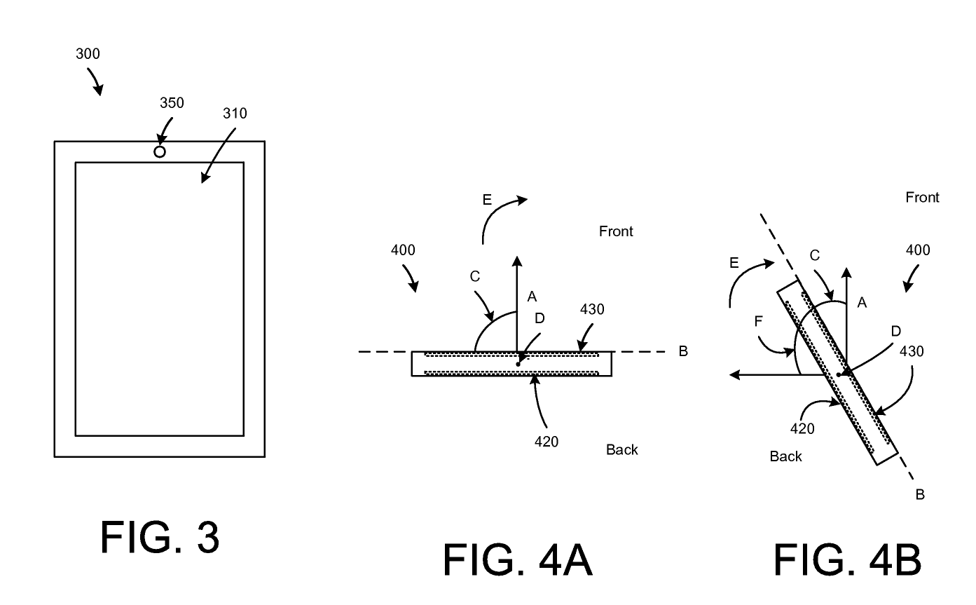

In some embodiments, the sensor 140 can include one or more accelerometers, one or more gyroscopes, one or more image capture devices, and/or so forth. If the sensor 140 is an accelerometer, the accelerometer can be used to detect the initiation of rotational movement of the computing device 100. One or more gyroscopes can be used to determine an orientation of the computing device 100 when one or more of the displays 120, 130 is facing a particular direction. In some embodiments, one or more image capture devices can be used to determine whether one or more of the displays 120, 130 is facing a user (or an object). An example of a computing device that includes an image capture device used to determine orientation of the computing device is described, for example, in connection with FIG. 3.

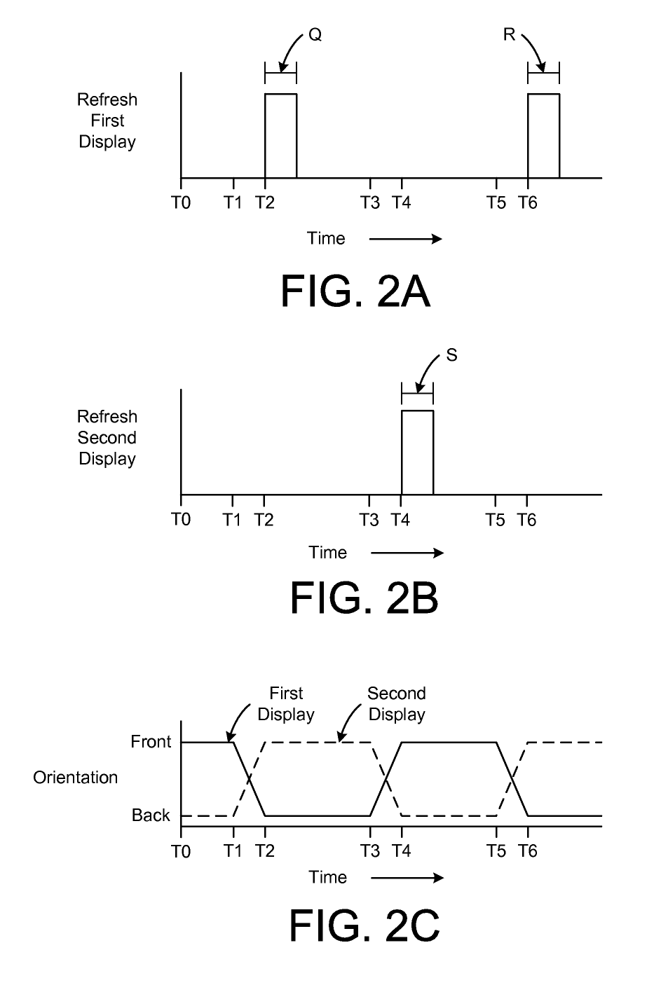

FIGS. 2A through 2C are timing diagrams that illustrate operation of a computing device according to an embodiment. The computing device can be similar to the computing device 100 shown in FIGS. 1A through 1C. Specifically, FIG. 2A is a graph that illustrates refreshing of a first display on a first side of the computing device, and FIG. 2B is a graph that illustrates refreshing of a second display on a second side of the computing device. FIG. 2C is a graph that illustrates orientation of the computing device.

As shown in FIG. 2A, starting at times T2 and T6, the first display is refreshed. In this embodiment, the first display is configured to display content (e.g., display content statically) between the refresh times. For example, a page of text associated with an e-book can be displayed on the first display between times T0 and T2. Starting at time T2, the first display can be refreshed so that an additional page of text replaces (at least partially replaces) the page of text while the first display is being refreshed. After the refreshing of the first display is completed, the additional page of text may be displayed on the first display until the first display is once again refreshed starting at time T6.

As shown in FIG. 2B, the second display is similarly refreshed. However, as shown in FIG. 2B, the second display is refreshed starting at time T4 which is in between the refreshing of the first display starting at times T2 and T6.

As shown in FIG. 2C, the orientation of the first display and the second display are shown. The orientation of the first display is represented with the solid line and the orientation of the second display is illustrated with a dashed line.

As shown in FIG. 2C, the first display is in a front orientation (e.g., a front-side orientation) between times T0 and T1, and between times T4 and T5. The first display is in a back orientation (e.g., a back-side orientation) between times T2 and T3 and after time T6. The second display is in a front orientation between times T2 and T3, and after time T6, and is in a back orientation between times T0 and T1, and between times T4 and T5. The sloped lines between times T1 and T2, T3 and T4, and T5 and T6 each represent rotation of the computing device. For example, the first display is in the front orientation between times T0 and T1 and is rotated (as represented by a sloped line) between times T1 and T2 to the back orientation starting at time T2.

FIGS. 2A through 2C collectively illustrate that the display that is rotated toward the back orientation (or away from the front orientation) is refreshed. For example, the first display is rotated away from the front orientation toward the back orientation between times T1 and T2. When the first display is in the back orientation starting at time T2, the first display is also refreshed starting at time T2. Similarly, the second display is rotated away from the front orientation toward the back orientation between times T3 and T4. When the second display is in the back orientation starting at time T4, the second display is also refreshed starting at time T4. Thus, the display that is facing away from a user is automatically refreshed, and the refreshing of each of the displays is staggered as illustrated in FIGS. 2A and 2B.

The orientation and refreshing of the first display in the second display can be described in the context of content associated with an e-book. For example, a first page of the e-book can be displayed on the first display when the first display is in the front orientation between times T0 and T1. A second page of the e-book (which is in a back orientation facing away from a user) can be displayed on the second display between times T0 and T1. When the computing device is rotated between times T1 and T2, the second page of the e-book will remain displayed on the second display because the second display is not refreshed when the computing device is rotated so that the second display is moved from the back orientation to the front orientation. The first display, however, is refreshed when the first display is moved to the back orientation (which is facing away from a user) starting at T2 with a third page of the e-book.

Although FIGS. 2A through 2C illustrate that refreshing occurs after one or more of the displays is moved to (and reaches) the back orientation, in some embodiments, the refreshing can be triggered (e.g., triggered in response to a sensor) with a different timing. For example, refreshing of the first display and/or the second display can be triggered during rotation of the computing device. In some embodiments, refreshing of the first display and/or the second display can be triggered when rotation of the computing device is started.

In some embodiments, refreshing of the first display can be triggered (e.g., triggered in response to an indicator from a sensor) with the timing that is different than the refreshing of the second display. For example, refreshing of the first display can be triggered while the computing device is rotating (e.g., is rotated beyond a specified angle), and refreshing of the second display can be triggered after rotation of the computing device has been completed. More details related to refreshing in response to rotating are described in connection with FIGS. 4A and 4B.

Refresh time periods Q and R of the first display are shown in FIG. 2A, and refresh time period S of the second display is shown in FIG. 2B. In some embodiments, the refresh time periods Q, R of the first display and/or refresh time period S of the second display can be a relatively short period of time. For example, the refresh time periods Q, R of the first display can be approximately less than a second (e.g., 0.5 seconds, 0.3 seconds). In some embodiments, the refresh time periods Q, R of the first display can be greater than or equal to one second (e.g., two seconds). In some embodiments, the refresh time periods Q, R of the first display can be different than the refresh time period S of the second display.

In some embodiments, the refresh time periods Q, R of the first display and/or the refresh time period S of the second display can be shorter than, equal to, or greater than the time period during which rotation (e.g., a typical rotation) of the computing device occurs. For example, the refresh time periods Q, R and/or the refresh time period S can be shorter than the rotation time period between times T1 and T2.

In some embodiments, refreshing of the first display and/or the second display may only be triggered when the rotation is faster than a threshold period of time (also can be referred to as a rotation threshold time period). In such embodiments, refreshing of the first display and/or the second display may not be triggered when rotation is slower than the threshold period of time. As a specific example, refreshing of the first display and/or the second display may be triggered when the rotation (e.g., at least 90° rotation) occurs during a time period approximately equal to, or slightly longer, than rotation time period between times T1 and T2 (which can approximately represent a typical time for 180° rotation of the computing device), but shorter than the time period between times T1 and T3. This functionality may be included in the computing device so that a user who stands up and walks around with the computing device may not unintentionally trigger refreshing as the computing device is moved (and slowly rotated) with the movements of the user. Instead, the computing device may only be refreshed in response to the computing device being rotated (e.g., rotated more than 120°) at a relatively fast rate (e.g., less than a second) with the intent to trigger refreshing.

In some embodiments, refreshing the one or more the displays of the computing device (or an indicator configured to trigger the refreshing) can be disabled (e.g., deactivated) for a period of time. In other words, the computing device can have a refreshing override function. For example, the refreshing functionality of the computing device can be disabled for a period of time so that a user reading content on the first display or the second display may pass (while rotating) the computing device to another person so that the second person may consume the content without the displays being refreshed. As another example, the refreshing functionality of the computing device can be disabled for a period of time so that a user reading content on the first display and/or the second display may move without refreshing of the first display and/or the second display of the computing device being unintentionally triggered.

In some embodiments, the display 120 of the computing device 100 can be used to consume pages of a first type of content and display 130 of the computing device 100 can be used for consuming a second type of content. The second type of content can be related to the first type of content or can be independent of the first type of content. The refreshing of at least one of the displays 120, 130 can be disabled (as described above) so that a user can refer to the content displayed thereon without triggering refreshing. As a specific example, the display 120 of the computing device 100 can be used for reading an e-book and the display 130 of the computing device 100 can be used to display reference material or notes related to the e-book on the display 120. Refreshing of the e-book pages on the display 120 can be triggered (e.g., triggered using a button or other type of movement), while the content on the display 130 of the computing device 100 can be referred to periodically while a user is consuming the e-book on display 120.

Referring back to FIGS. 1A through 1C, in some embodiments, the computing device 100 can include one or more input device regions (not shown in FIGS. 1A through 1C). The input device region(s) can include various types of input devices such as, for example, a keyboard, one or more buttons, an electrostatic touchpad to control a mouse cursor, etc. In some embodiments, an input device region can be disposed below one or more of the displays 120, 130. For example, an input device region including a keyboard and/or one or more buttons can be disposed below the display 120, while an input device region may be excluded from the side including display 130. In other words, an input device region may be included in one side of the computing device 100, but not on the other side of the computing device 100.

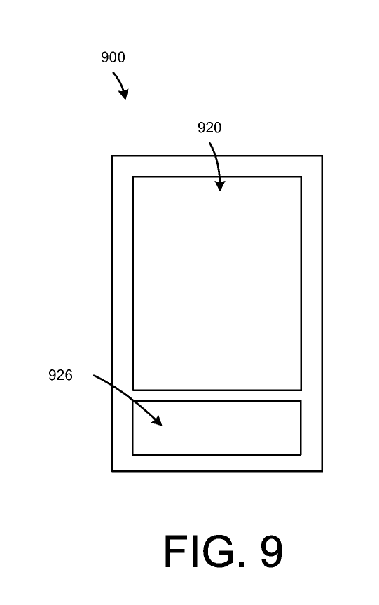

One or more input devices included in the input device region can be used to control one or more functions of the computing device. For example, an input device can be used to access one or more files (e.g., electronics books) stored in a memory (not shown) of the computing device 100, trigger pagination of an e-book, and/or so forth. An example of a computing device that includes an input device region is described in connection with FIG. 9.

In some embodiments, one or more of the displays 120, 130 can include a touch sensitive display. In some embodiments, one or more of the displays 120, 130 can be, or can include, for example, an electrostatic touch device, a resistive touchscreen device, a surface acoustic wave (SAW) device, a capacitive touchscreen device, a pressure sensitive device, a surface capacitive device, a projected capacitive touch (PCT) device, and/or so forth. In some embodiments, each of the displays 120, 130 can be a different type of display. For example, in some embodiments, the display 120 can be an electronic ink display and the display 130 can be an LCD display or a touch sensitive LCD display.

In some embodiments, if one or more of the displays 120, 130 is a touch sensitive display, the display(s) can function as an input device. For example, display 130 can be a touch sensitive display that can be configured to display a virtual keyboard (e.g., emulate a keyboard) that can be used by a user as an input device. In some embodiments, one or more gestures (e.g., finger strokes, hand movements) can be used to control content displayed on one or more of the displays 120, 130.

In some embodiments, the touch sensitive surface can be disposed over one or more of the displays 120, 130 that is an electronic ink display. In such embodiments, the touch sensitive surface (e.g., via one or more gestures or other types of touches) can be configured to trigger one or more signals that can be used to control (e.g., control content on) the displays 120, 130 and/or another function of the computing device 100. For example, the touch sensitive surface can be used to access one or more files (e.g., electronic books (i.e., e-book)) stored at the computing device 100, scroll through and/or select content, and so forth.

In some embodiments, one or more input device included on a back side of the computing device 100 (facing away from a user) can be used to control content on the front side of the computing device 100 (facing toward a user). For example, an input device included on the side of the display 130 can be used to control content (e.g., control scrolling of content, refreshing of content, selecting of content) on the display 120 when the display 120 is facing a user. Thus, the content displayed on display 120 may not be obstructed by a user's fingers (which are instead using an input device on the back side of the computing device 100) while controlling the content displayed on the display 120. In such embodiments, one or more gestures (e.g., finger strokes, hand movements) on display 120 can be used to control content displayed on display 130.

Although the displays 120, 130 shown in FIGS. 1A through 1C are the same size (or approximately the same size), in some embodiments, display 120 can be a different size than the display 130. For example, the display 120 can have a viewable area that is different than a viewable area of the display 130. In some embodiments, a resolution of the display 120 can be different than a resolution of the display 130.

In some embodiments, the computing device 100 can be, for example, a wired device and/or a wireless device (e.g., wi-fi enabled device) and can be, for example, a personal computing device, a mobile phone, a personal digital assistant (PDA), and/or so forth. In some embodiments, the computing device 100 can have functionality beyond that of an e-book device. For example, the computing device 100 can have general-purpose processing capabilities. The computing device 100 can be configured to operate based on one or more platforms (e.g., one or more similar or different platforms) that can include one or more types of hardware, software, firmware, operating systems, runtime libraries, and/or so forth.

FIG. 3 is a diagram that illustrates a front side of a computing device 300 that includes an image capture device 350. The computing device 300 includes a display 310. Although not shown in FIG. 3, another display is disposed behind the display 310 so that the computing device 300 can be used in a fashion similar to the computing devices described above. In other words, another display is disposed on a back side of the computing device 300.

In this embodiment, the image capture device 350 is configured to detect an orientation (e.g., a front orientation, the back orientation) of the computing device 300 with respect to a user. For example, the image capture device 350 can be configured to capture one or more images (e.g., indicators) that can be used by the computing device 300 to determine an orientation of the computing device 300.

As a specific example, the image capture device 350 (which is a type of sensor) can be configured to capture one or more images (e.g., indicators) of a user viewing the display 310 of the computing device 300. In such instances, the image(s) can be analyzed by the computing device 300 to determine that the display 310 is facing toward the user. In response to determining that the display 310 is facing toward the user, the display on the back side of the computing device 300 can be triggered to refresh. In some embodiments, the computing device 300 can include one or more facial recognition software and/or hardware components configured to analyze the image(s) to determine that the display 310 is facing toward the user. In some embodiments, one or more images captured by the image capture device 350 while the computing device 300 is facing away from the user can be used to determine that the display 310 is facing away from the user.

As another example, in some embodiments, one or more images captured by the image capture device 350 can be used to determine movement of the computing device 300. In such embodiments, one or more pixels associated with a first image captured by the image capture device 350 can be compared with one or more pixels of a second image captured by the image capture device 350 to determine that the computing device 300 is being rotated (e.g., rotated so that the display 310 will no longer be facing a user, rotated so that the display will be facing a user).

In some embodiments, the image capture device 350 can be configured to capture images that can be used to determine an orientation of the computing device 300 during specific intervals of time. For example, the image capture device 350 can be configured to capture an image every few seconds (e.g., every second, every 3 seconds, every 5 seconds). In some embodiments, the image capture device 350 can be configured to capture images randomly. In some embodiments, a refresh of the display 310 on the front side of the computing device 300 and/or a refresh of the display (not shown) on the back side of the computing device 300 can be triggered in response to an orientation of the computing device 300 determined based on one or more images captured by the image capture device 350.

In some embodiments, the image capture device 350 can be configured to capture images in response to movement (e.g., movement more than a threshold amount) of the computing device 300. In some embodiments, the image capture device 350 can be in a standby state (e.g., standby mode) while the computing device 300 is not moving (e.g., is not moving a threshold amount). For example, the image capture device 350 can be configured to capture one or more images in response to a user starting to rotate the computing device 300 (e.g., rotate the computing device 300 more than a threshold amount). In such embodiments, a refresh of the display 310 on the front side of the computing device 300 and/or a refresh of the display (not shown) on the back side of the computing device 300 can be triggered in response to an orientation of the computing device 300. The orientation can be determined based on the one or more images that are captured by the image capture device 350 in response to the movement.

Although not shown in FIG. 3, an additional image capture device can be disposed on a back side of the computing device 300. In some embodiments, the additional image capture device can be used to determine an orientation of the computing device 300 with respect to a user of the computing device 300. In some embodiments, one or more images captured by the image capture device 350 can be used in conjunction with one or more images captured by the additional image capture device to determine an orientation of the computing device 300.

For example, the two image captures devices can be configured so that refreshing does not occur until images from at least one of the two image capture devices positively identifies a physical feature (e.g., an eye, a face) of a user. Thus, refreshing may not be erroneously triggered if the computing device 300 is, for example, temporarily placed on a table and the image capture device on a front side of the computing device 300 and that was facing a user is no longer facing the user. The erroneous refreshing can be avoided because the refreshing may not be triggered until the image capture device on the back side of the computing device 300 registers the face of the user.

In some embodiments, images captured by the image capture device 350 can be used in conjunction with another type of sensor to determine an orientation of the computing device 300. For example one or more images captured by the image capture device 350 can be analyzed in conjunction with an indicator (e.g., a signal) from, for example, an accelerometer to determine whether or not the computing device 300 is being rotated in a particular direction.

In some embodiments, the image capture device 350 may be included in a different portion of the computing device 300 than that shown in FIG. 3. For example, in some embodiments, the image capture device 350 may be included in a side portion of the computing device 300. In some embodiments, the image capture device 350 can be a low resolution image capture device configured for detection of an orientation of the computing device 300. In some embodiments, the image capture device 350 can be, for example, an infrared sensor, a light sensor (e.g., an ambient light sensor), a motion sensor, and/or so forth. In embodiments where the image capture device 350 is, for example, a light sensor, the light sensor can trigger refreshing in response to changes in light (e.g., a level of light, a type of light) detected by the light sensor. In such embodiments, the light sensor can be used to trigger refreshing because the side of the computing device 300 facing away from the user may be darker than the side of the computing device 300 facing toward the user. A change in a level of light detected by the image capture device 350 can be an indicator of the computing device 300 being flipped.

FIG. 4A is a side view diagram that illustrates a computing device 400 oriented so that a display 430 is a front orientation (e.g., facing toward a user so that the display 430 may be viewed by the user) and a display 420 is in a back orientation (e.g., facing away from the user so that the display 420 may not be viewed by the user). In this embodiment, when in the front orientation, the display 430 is aligned along, or disposed within, a plane B and is approximately orthogonal to direction A, which represents the direction facing toward a user. As shown in FIG. 4A, an angle C between the plane B and the direction A is approximately 90°.

As shown in FIG. 4B, the computing device 400 shown in FIG. 4A is rotated away from the front orientation so that the angle C between the plane B and the direction A is less than 90°. In this embodiment, the computing device 400 is rotated in a clockwise direction along direction E from the front orientation shown in FIG. 4A to the orientation shown in FIG. 4B. In some embodiments, the orientation shown in FIG. 4B can be referred to as a transition orientation, because the computing device 400 (or displays thereof) is not in (e.g., not completely in) the front orientation or in the back orientation.

The computing device 400 can be configured so that one or more of the displays 420, 430 are refreshed in response to the computing device 400 rotating so that the angle C satisfies a threshold condition (e.g., is less than or equal to a threshold angle of rotation). For example, the computing device 400 can be configured so that the display 430 is triggered to start refreshing when the angle C is less than 30°. Thus, the display 430 can start refreshing when the computing device is rotated approximately 60° (shown as angle F) from the front orientation shown in FIG. 4A (assuming that the angle C in FIG. 4A is approximately 90°). In some embodiments, rotation of the computing device 400 can be detected using one or more sensors (e.g., gyroscopes) included within the computing device 400.

In some embodiments, the threshold angle can be different than that described above. For example, the threshold angle can be less than 30° or greater than 30°. In some embodiments, the threshold angle can be defined by a user in, for example, a user profile stored within the computing device 400. In some embodiments, the threshold angle can be included in (e.g., stored in) a default setting of the computing device 400.

As shown in FIGS. 4A and 4B, the computing device 400 is configured to trigger refreshing of one or more of the displays 420, 430 in response to rotation about an axis D (which is approximately orthogonal to the page). In some embodiments, one or more of the displays 420, 430 can be refreshed in response to rotation about an axis different than the axis D. For example, the display 420 and/or display 430 can be refreshed in response to rotation about an axis nonparallel to D and/or about several different axes. In some embodiments, the display 420 and/or the display 430 can be refreshed in response rotation about an axis nonparallel to D and disposed within a plane B.

In some embodiments, the computing device 400 can include one or more gyroscopes, image capture devices, and/or accelerometers that can be used to detect the orientation of the computing device 400 after being rotated about an axis (e.g., an axis nonparallel to axis D). In such embodiments, the gyroscopes, image capture devices, and/or accelerometers can be used to reorient content within the displays 420, 430 so that the content is right side up with respect to a user.

In some embodiments, the display 420 and/or the display 430 can be refreshed in response rotation within the plane B (or within a plane substantially parallel to plane B). For example, the computing device 400 may be oriented so that the display 420 is facing the user (and continues to face the user) while the computing device 400 is being rotated (e.g., rotated 45°, 90°, 180°) within the plane B. In response to, or during the rotation, the display 420 may be refreshed. In such embodiments, content within the display 420 may be reoriented so that the content is right side up with respect to the user.

In some embodiments, the computing device 400 can be configured to detect reverse rotation and trigger refreshing of one or more of the displays 420, 430 accordingly. For example, the computing device 400 can be configured so that the display 430 is triggered to start refreshing when the computing device 400 is rotated from the front orientation shown in FIG. 4A towards the orientation shown in FIG. 4B along direction E beyond a threshold angle. The display 430 can be refreshed so that a first page of text is replaced with a second page of text (in a forward direction with respect to e-book pages). A user of the computing device 400 can start rotating the computing device 400 so that the user can read the second page of text after having finished consumption of the first page of text (in a backward direction with respect to e-book pages). If the computing device 400 is rotated by the user in the reverse direction (in a direction opposite direction E), the display 430 can be refreshed so that the second page of text is replaced with the first page of text (in a backward direction with respect to the e-book pages). The computing device 400 can be configured to refresh in this fashion when rotated in the reverse direction so that the user to refer back to or re-read the first page of text.

In some embodiments, the computing device 400 can be configured to refresh in a forward direction (with respect to e-book pages) when rotated in one direction (i.e., a clockwise direction) and can be configured to refresh in a backward direction (with respect to e-book pages) when rotated in another direction (i.e., a counterclockwise direction). Refreshing in the forward direction can be referred to as forward refreshing, and refreshing in a backward direction can be referred to as backward refreshing.

In some embodiments, the computing device 400 can be configured to detect reverse rotation and trigger refreshing in a backward direction only when the reverse rotation occurs before one or more of the displays 420, 430 is completely rotated (or rotated beyond a specified angle) to one of the front orientation or the back orientation. For example, the computing device 400 can be configured so that the display 430 is triggered to start forward refreshing when the computing device 400 is rotated from the front orientation shown in FIG. 4A towards the orientation shown in FIG. 4B along direction E beyond a threshold angle. The display 430 can be backward refreshed only if the computing device 400 is rotated by the user in the reverse direction (in a direction opposite direction E) before the display 430 is completed rotated to the back orientation.

Although the front orientation of the display 430 of the computing device 400 is illustrated in FIG. 4A as being a horizontal orientation (e.g., a horizontal position), in some embodiments, the front orientation (or starting orientation/position) of the display 430 of the computing device 400 for triggering refreshing may not be a horizontal orientation. In other words, the front orientation (or starting orientation) of the computing device 400 can be an orientation where the display 430 is not disposed within, or aligned along, the plane B (which is horizontal). Refreshing of one or more of the displays 420, 430 can be triggered in response to rotation, or other movement, from the non-horizontal front orientation of the computing device 400.

In some embodiments, the computing device 400 can be configured to detect a starting orientation of the computing device 400 from which refreshing can be triggered. For example, in some embodiments, the computing device 400 can be configured to determine that a particular orientation of the computing device 400 is a starting orientation of the computing device 400 from which refreshing can be triggered when the computing device 400 is substantially at rest (or has not been rotated beyond a specified angle) in the particular orientation. In other words, the particular orientation of the computing device 400 can be selected as the starting orientation of the computing device 400 when the computing device 400 is in the particular orientation for a specified period of time. In some embodiments, the starting orientation of the computing device 400 can be selected (or otherwise defined) with each refreshing of one or more of the displays 420, 430 of the computing device 400.

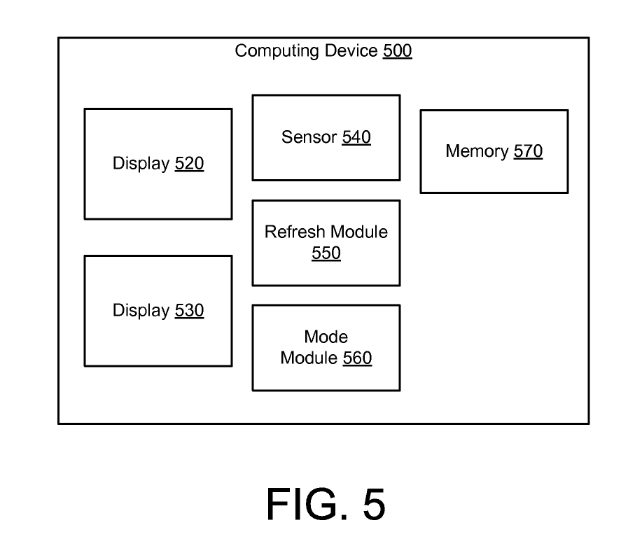

FIG. 5 is a block diagram that illustrates a computing device 500 that includes multiple displays. As shown in FIG. 5, the computing device 500 includes display 520 and display 530. The computing device 500 includes a sensor 540 that can be configured to detect an orientation (and/or a movement) of the computing device 500 (and/or a portion thereof such as one or more of the displays 520, 530). The sensor 540 can be configured to produce one or more indicators (e.g., signals) that represent, or can be used to determine (using hardware and/or software associated with the sensor 540), the orientation of the computing device 500.

In response to the orientation of the computing device 500 being detected by the sensor 540 (and associated hardware and/or software), the refreshed module 550 can be configured to trigger a refresh of one or more of the displays 520, 530. For example, in response to an indicator from the sensor 540 that the computing device 500 is being rotated at a particular speed and in a particular direction, the refreshed module 550 can be configured to trigger a refresh (e.g., a forward refresh, a backward refresh) of one or more of the displays 520, 530.

As shown in FIG. 5, the computing device 500 includes a mode module 560. The mode module 500 can be configured to indicate a particular refresh mode of the computing device 500 that can be used by the refresh module 550 to trigger refreshing of one or more of the displays 520, 530. In some embodiments, a refresh mode can indicate a pattern in which each of the displays 520, 530 should be refreshed in response to the computing device 500 being moved (e.g., rotated).

For example, in a flipping refresh mode, the displays 520, 530 may be refreshed in an alternating pattern starting with either of the display 520 or the display 530 as the computing device 500 is rotated. In a non-flipping refresh mode, only one of the displays may be refreshed as a user consumes content displayed on the display. For example, display 520 may be refreshed with pages from an e-book without display 530 being refreshed during consumption of the pages of the e-book by a user. The computing device 500 may operate in such a fashion if the display 530 is not functioning properly and/or if the user selects the non-flipping mode using the mode module 560. Various modes of the computing device 500 can be specified. For example, in a particular mode, the display 520 may be refreshed multiple times with new content before the display 530 is refreshed with new content. In some embodiments, the mode module 560 may be used by a user to define a customized refresh mode that can be, for example, stored in the memory 570.

In some embodiments, one or more definitions of a refresh mode can be stored in the memory 570 where the refresh mode can be accessed by and/or otherwise manipulated by the mode module 560. The mode module 560 can also be used by a user to select a particular refresh mode. In some refresh modes, the refresh module 550 can be configured to trigger refreshing of one or more of the displays 520, 530 in response to one or more user interface buttons being actuated rather than in response to orientation and/or movement (e.g., rotation) of the computing device 500 as detected by the sensor 540.

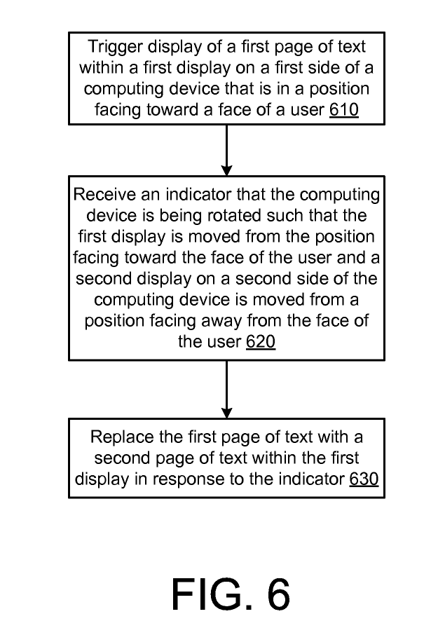

FIG. 6 is a flowchart that illustrates a method of operating a computing device that has multiple displays. The computing device can be similar to any of the computing devices described herein.

As shown in FIG. 6, display of a first page of text is triggered within a first display on a first side of a computing device that is in a position facing toward a face of a user (block 610). In some embodiments, the position facing toward the face of the user can be referred to as a front orientation. The first page of text can be from an e-book, and the computing device can be, in some embodiments, a dedicated e-book device.

An indicator that the computing device is being rotated such that the first display is moved from the position facing toward the face of the user and a second display on a second side of the computing device is moved from a position facing away from the face of the user is received (block 620). In some embodiments, the indicator can be produced by a sensor (and/or associated hardware and/or software), such as an image capture device, a gyroscope, an accelerometer, and/or so forth, included within the computing device. In some embodiments, the position facing away from the face of the user can be referred to as a back orientation. The first display can be moved from the front orientation toward a back orientation, and the second display can be moved from the back orientation toward the front orientation. In some embodiments, the indicator can be produced in response to the computing device being rotated beyond a particular point (e.g., beyond a threshold angle), at a specified speed, and/or so forth.

The first page of text is replaced with a second page of text within the first display in response to the indicator (block 630). In some embodiments, the replacement of the first page of the text with the second page of the text within the first display can be referred to as refreshing of the first display.

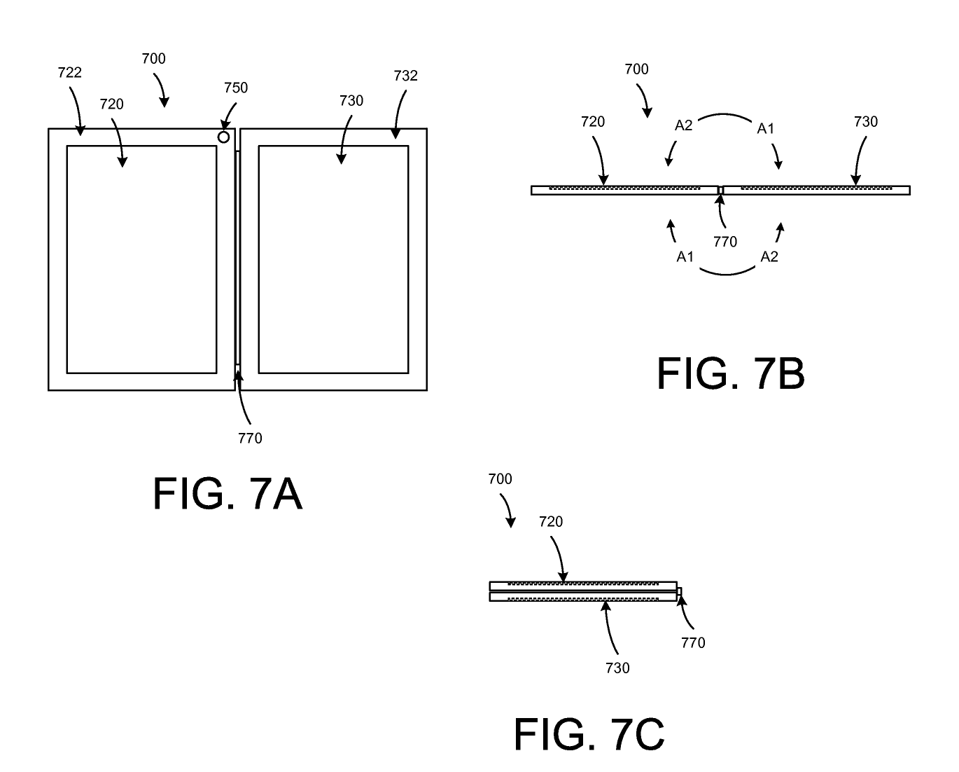

FIGS. 7A through 7C are diagrams of a computing device 700 that includes multiple displays and that can change configuration. The computing device 700 includes a display 720 and display 730. The display 720 and the display 730 are included, respectively, in different portions—portion 722 and portion 732—of the computing device 700. The portion 722 and the portion 732 are coupled via a hinge 770.

FIG. 7A is a front view of the computing device 700 while the computing device 700 is in an open configuration. FIG. 7B is a diagram of a side view of the computing device 700 while the computing device is in the open configuration. FIG. 7C is a diagram of a side view of the computing device 700 while the computing device is in a closed configuration. In this embodiment, the computing device 700 can be moved from the open configuration (shown in FIGS. 7A and 7B) to the closed configuration (shown in FIG. 7C) via the hinge 770.

When the computing device 700 is in the open configuration, the display 720 and the display 730 are facing in the same (or approximately the same direction). In this embodiment, the displays 720, 730 are aligned along the same plane when in the open configuration. In some embodiments, each of the displays 720, 730 can each be aligned along planes that are nonparallel when in the open configuration. In some embodiments, the open configuration shown in FIGS. 7A and 7B can be referred to as a side-by-side configuration.

When in the computing device 700 is in the flipping configuration shown in FIG. 7C, the display 720 is facing in a direction opposite the display 730. In other words, the display 720 is facing away from the display 730 when the computing device is in the flipping configuration. In some embodiments, the flipping configuration shown in FIG. 7C can be referred to as a front-to-back configuration. Although not shown in FIGS. 7A through 7C, in some embodiments, the computing device 700 can have a closed configuration where the display 720 is directly facing toward the display 730 so that neither display 720 nor display 730 can be viewed by a user.

When the computing device 700 is in the flipping configuration shown in FIG. 7C, the displays 720, 730 can be refreshed in accordance with the methods described above. In other words, when the computing device 700 is in the flipping configuration, the displays 720, 730 can be refreshed using a flipping mode where the displays 720, 730 can be refreshed in an alternating fashion as the computing device 700 is rotated in one direction (e.g., a clockwise direction) and/or another direction (e.g., a counterclockwise direction).

The computing device 700 can be configured so that a user can consume (e.g., read, view) content (e.g., text, images) displayed (e.g., rendered) on the displays 720, 730 in an alternating fashion when the computing device 700 is in the open configuration (or side-by-side configuration). For example, a user can consume content displayed on the display 720. After the user has completed consumption of the content displayed on the display 720, the user can proceed to consume content displayed on the display 730. While the user is consuming content displayed on the display 730, display 720 can be refreshed with new content so that after the user has completed consumption of the content displayed on the display 730, the user can proceed to consume the new content displayed on the display 720.

As shown in FIG. 7A, the computing device 700 includes an image capture device 750 that can be used, at least in part, to detect whether a user has moved to consume content displayed on the display 720 or the display 730 when the computing device 700 is in the open configuration (e.g., the side-by-side configuration). For example, the image capture device 750 can be configured to periodically capture one or more images of the user (e.g., an eye of a user) that can be used to determine whether the user is facing toward (and viewing) content displayed on the display 720 or is facing toward (and viewing) content displayed on the display 730. Accordingly, refreshing of the displays 720, 730 can be triggered in response to a consumption pattern of a user.

As a specific example, the computing device 700 can be configured so that a first page of an e-book can be displayed (e.g., rendered) on, for example, display 720 when the computing device is in the open configuration. While the user is reading the first page on the display 720, the display 730 can be configured to display a second page of the e-book. After the user has read the first page of the e-book displayed on the display 720, the image capture device 750 can be used to determine that the user has moved (e.g., shifted, changed) to view content displayed on the display 730. After, or while, the user has moved so that the user can read the second page of the e-book displayed on the display 730, the display 720 can be refreshed with the third page of the e-book.

In some embodiments, refreshing of the displays 720, 730 while the computing device 700 is in the open configuration can be referred to as a side-by-side refresh mode. In some embodiments, the refresh mode of the computing device 700 can be changed in response to the computing device 700 being moved from the open configuration to the flipping configuration. For example, the computing device 700 can be configured to operate with a side-by-side refresh mode by default when the computing device 700 is in the open configuration. In response to the computing device 700 being moved to the flipping configuration, the computing device 700 can be configured to operate with a flipping refresh mode by default. Although not shown, the computing device 700 can include one or more buttons that can be used by a user to trigger refresh of the displays 720, 730 when the computing device 700 is in the open configuration (shown in FIGS. 7A and 7B) and/or the flipping configuration (shown in FIG. 7C).

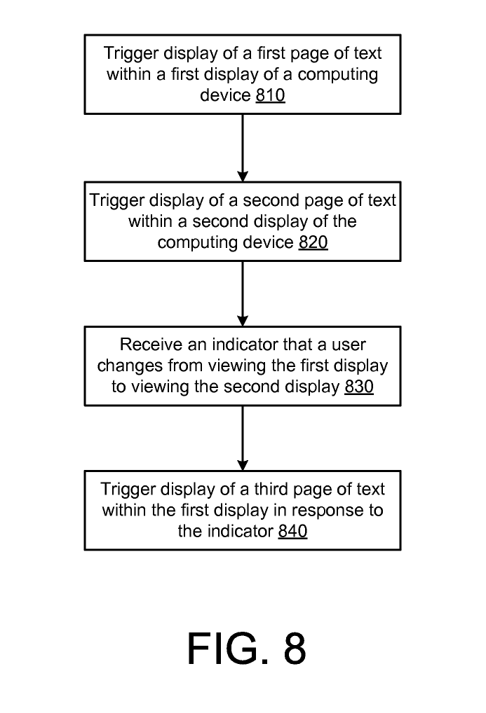

FIG. 8 is a flowchart that illustrates a method for refreshing content of a computing device with multiple displays. The computing device can be similar to, for example, the computing device 700 shown in connection with FIGS. 7A through 7C.

Display of a first page of text is triggered within a first display of a computing device (block 810). In some embodiments, the first page of text can be from an e-book, and the computing device can be, in some embodiments, a dedicated e-book device.

Display of a second page of text is triggered within a second display of the computing device (block 820). In some embodiments, the computing device can be in an open configuration, or a side-by-side configuration, where the first display is disposed next to (or adjacent to) the second display and both displays are facing a user.

An indicator that a user changed from viewing the first display to viewing the second display is received (block 830). In some embodiments, the indicator can be produced by a sensor, such as an image capture device.

Display of a third page of text is triggered within the first display in response to the indicator (block 840). In some embodiments, the first page of text within the first display can be replaced with the third page of text. In other words, the first display can be refreshed in response to the indicator.

FIG. 9 is a diagram of a computing device 900 that includes an input device region 926. As shown in FIG. 9, the computing device 900 includes a display 920 on the frontside of the computing device 900, and although not shown in FIG. 9, another display is disposed on a backside of the computing device 900 (similar to the computing devices described above). The input device region 926 can include various types of input devices such as, for example, a keyboard, one or more buttons, an electrostatic touchpad to control a mouse cursor, etc. Although shown in FIG. 9 as being disposed below the displays 920, in some embodiments, the computing device 900 can include more than one input device region and/or the input device region 926 can be oriented in a different portion of the computing device 900. In some embodiments, the input devices included in the input device region 926 can be used to control one or more functions of the computing device. For example, an input device included in the input device region 926 can be used to access one or more files (e.g., electronics books) stored in a memory (not shown) of the computing device 900, trigger pagination of an e-book, and/or so forth.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device (computer-readable medium, a non-transitory computer-readable storage medium, a tangible computer-readable storage medium) or in a propagated signal, for processing by, or to control the operation of, data processing apparatus, e.g., a programmable processor, a computer, or multiple computers. In some implementations, a computer-readable storage medium can be configured to store instructions that when executed cause a computing device to perform a process. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be processed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the processing of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT), light emitting diode (LED), or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments. It should be understood that they have been presented by way of example only, not limitation, and various changes in form and details may be made. Any portion of the apparatus and/or methods described herein may be combined in any combination, except mutually exclusive combinations. The embodiments described herein can include various combinations and/or sub-combinations of the functions, components and/or features of the different embodiments described.

1. A computing device, comprising:
a first electronic-ink display on a first side of the computing device;
a second electronic-ink display on a second side of the computing device, the second electronic-ink display configured to selectively reflect ambient light;
an image capture device configured to capture a first image while the first electronic-ink display of the computing device is facing in a first direction toward a face of a user, and configured to capture a second image after the first electronic-ink display of the computing device is rotated from facing in the first direction to facing in a second direction away from the face of the user and opposite the first direction such that the second electronic-ink display is facing toward the face of the user; and
a refresh module configured to trigger at least one of the second electronic-ink display to refresh an image displayed by the second electronic-ink display or the first electronic-ink display to refresh an image displayed by the first electronic-ink display based on an analysis of the second image.

2. (canceled)

3. The computing device of claim 1, wherein the first electronic-ink display is configured to at least one of rearrange charged particles to form the image displayed by the first electronic-ink display or is based on electrophoretic display technology.

4. (canceled)

5. The computing device of claim 1, further comprising:
a mode module configured to trigger deactivation of the first electronic-ink display in response to an indicator that the computing device has changed from a flipping mode to a non-flipping mode, refreshing of the first electronic-ink display and the second electronic-ink display are refreshed in an alternating fashion when the computing device is in the flipping mode.

6. The computing device of claim 1, wherein the at least one of the image displayed by the first electronic-ink display or the image displayed by the first electronic-ink display is refreshed in response to the computing device being rotated more a threshold angle from the first direction.

7. The computing device of claim 1, wherein the refresh module is configured to trigger the second electronic-ink display to refresh starting at a first time when the computing device is in a flipping mode,
the computing device further comprising:
a mode module configured to receive an indicator that the computing device has changed from the flipping mode to a non-flipping mode, the refresh module configured to trigger a refresh of the second electronic-ink display starting at a second time after the first time without triggering a refresh of the first electronic-ink display between the first time and second time.

8. The computing device of claim 1, wherein the refresh module is configured to trigger the second electronic-ink display to refresh a specified time period after the at least one of the first image or the second has been produced by the image capture device.

9. The computing device of claim 1, wherein the computing device is configured to change from a closed configuration where the first electronic-ink display faces the second electronic-ink display to an open configuration where the first electronic-ink display faces away from the second electronic-ink display.

10. The computing device of claim 1, wherein a touch sensitive surface is disposed over at least one of the first electronic-ink display or the second electronic-ink display.

11. The computing device of claim 1, wherein the second electronic-ink display is refreshed in response to rotation of the computing device occurring during a time period shorter than a threshold rotation time period.

12. The computing device of claim 1, wherein the second electronic-ink display is configured to display a first page of content, the second electronic-ink display is configured to replace the first page of content with a second page of content when refreshed,
the computing device further comprising:
a control mechanism disposed on the first side of the computing device, the second page of content displayed on the second electronic-ink display being modified in response to the control mechanism on the first side of the computing device being activated.

13. A non-transitory computer-readable storage medium storing instructions that when executed cause a computing device to perform a process, the instructions comprising instructions to:
trigger display of a first page of content within a first display on a first side of the computing device that is in a position facing toward a face of a user;
capture a first image of the face of the user using an image capture device;
capture a second image using the image capture device after the computing device is rotated such that the first display is moved from the position facing toward the face of the user and a second display on a second side of the computing device is moved from a position facing away from the face of the user; and
replace the first page of content with a second page of content within the first display based on an analysis of the second image.

14. The non-transitory computer-readable storage medium of claim 13, wherein further comprising:
producing, using a motion sensor, an indicator in response to the computing device being rotated until the second display is facing toward the face of the user.

15. The non-transitory computer-readable storage medium of claim 13, wherein at least one of the first display or the second display is an electronic-ink display.

16. The non-transitory computer-readable storage medium of claim 13, further comprising:
producing, using a motion sensor, an indicator in response to the computing device being rotated more than ninety degrees.

17. The non-transitory computer-readable storage medium of claim 13, wherein the computing device is substantially rotated about an axis disposed within a plane aligned along the second display, the first side of the computing device is opposite the second side of the computing device.

18. The non-transitory computer-readable storage medium of claim 13, wherein the first page of content is replaced with a second page of content while the computing device is in a flipping mode,
the instructions further comprising instructions to:
receive an indicator that the computing device has changed from the flipping mode to a non-flipping mode.

19. The non-transitory computer-readable storage medium of claim 13, further comprising instructions to:
activate the second display on the second side of the computing device.

20. The non-transitory computer-readable storage medium of claim 13, wherein the second page of content displayed on the second display remains unchanged while the first page of content of the first display is replaced with a third page during rotation of the computing device.

21. A non-transitory computer-readable storage medium storing instructions that when executed cause a computing device to perform a process, the instructions comprising instructions to:
trigger display of a first page of content within a first display on a first side of the computing device;
trigger display of a second page of content within a second display on a second side of the computing device;
receive a signal from an image capture device on the first side of the computing device, the signal representing a plurality of images;
define an indicator based on an analysis of the plurality of images that a user changes from viewing the first display to viewing the second display, the plurality of images including images captured while the first side of the computing device is facing away from a face of the user and the second side of the computing device is facing toward the face of the user; and
trigger display of a third page of content within the first display or the second display in response to the indicator.

22.-23. (canceled)

24. The non-transitory computer-readable storage medium of claim 21, wherein at least one of the first display or the second display is an electronic-ink display.

25. The computing device of claim 1, further comprising:
a motion sensor configured to detect that the first electronic-ink display of the computing device is rotated from facing in the first direction, the image displayed by the second electronic-ink display is triggered based on the detection by the motion sensor.

26. (canceled)

27. The computing device of claim 1, wherein the analysis of the image includes performing facial recognition, the image displayed by the second electronic-ink display refreshed in response to the computing device being rotated at more than at a threshold speed and more than a threshold angle from the first direction.

28. (canceled)

29. The non-transitory computer-readable storage medium of claim 13, wherein the second display is displaying a third page of content.

30. The non-transitory computer-readable storage medium of claim 13, wherein the rotating of the computing device is a first rotation,
the instructions further comprising instructions to:
trigger activation of a refresh override function configured to disable refreshing of the first display and the second display in response to a second rotation.

31. The non-transitory computer-readable storage medium of claim 13, wherein the second display is displaying a third page of content, the computing device is rotated in a first direction,
the instruction further comprising instructions to:
receive an indicator that the computing device is rotated in a second direction opposite the first direction after the computing device is rotated in the first direction; and
replace, within the first display and in response to the indicator, the second page of content with the first page of content in response to the indicator that the computing device is rotated in the second direction.

32. (canceled)

33. The computing device of claim 1, wherein the computing device is substantially rotated about an axis disposed within a plane aligned along the second display, the first side of the computing device is opposite the second side of the computing device.

34. The computing device of claim 1, wherein the refresh module is configured to trigger the at least one of the second electronic-ink display to refresh the image displayed by the second electronic-ink display or the first electronic-ink display to refresh the image displayed by the first electronic-ink display based on an analysis of the first image.

35. The computing device of claim 1, wherein the image capture device is a first image capture device on the first side of the computing device,
the computing device further comprising:
a second image capture device on the second side of the computing device.
